(19) United States
(12) Patent Application Publication
(10) Pub. No.: US 2025/0269334 A1
(43) Pub. Date: Aug. 28, 2025

(54) BUBBLE AND BUBBLE AGGREGATE, BUBBLE WATER, OXIDANT, REDUCTANT, AND BUBBLE MANUFACTURING METHOD

(71) Applicant: Panasonic Intellectual Property Management Co., Ltd., Osaka (JP)

(72) Inventors: Hidetaka SUGAYA, Shiga (JP); Katsutoshi FUKUDA, Kyoto (JP); Nobuya NAKADE, Osaka (JP)

(73) Assignee: Panasonic Intellectual Property Management Co., Ltd., Osaka (JP)

(21) Appl. No.: 19/206,377

(22) Filed: May 13, 2025

Related U.S. Application Data
(63) Continuation of application No. PCT/JP2023/039422, filed on Nov. 1, 2023.

(30) Foreign Application Priority Data
Nov. 15, 2022 (JP) 2022-182493
Dec. 1, 2022 (JP) 2022-192594

(51) Int. Cl. B01F 23/2375; B01F 23/23; B01F 101/00; C02F 1/34; C02F 1/66; C02F 103/04

(52) U.S. Cl. CPC B01F 23/2375; B01F 23/2319; C02F 1/34; C02F 1/66; B01F 2101/305; C02F 2103/04

(57) ABSTRACT

A bubble (10) is generated in a liquid, and has different isoelectric point (PI) value depending on a change in a pH value of the liquid, within a pH value range of 3 to 11.

### CROSS-REFERENCE TO RELATED APPLICATIONS

This application claims priority to Japanese Patent Applications No. 2022-182493 filed on Nov. 15, 2022 and No. 2022-192594 filed on Dec. 1, 2022. The entire disclosure of Japanese Patent Applications No. 2022-182493 and No. 2022-192594 is hereby incorporated herein by reference.

### BACKGROUND

### Technical Field

The present disclosure relates to a bubble and a bubble aggregate, bubble water, an oxidant, a reductant, and a method for producing a bubble, which are used in various applications.

### Description of the Related Art

In recent years, the diameter of the bubbles and the number of bubbles per unit of volume have been used to define the properties of micro-nano bubbles, which impart special functions to water. The reactivity of these micro-nano bubbles has mainly been predicted qualitatively based on the magnitude of the surface potential (zeta potential) and the polarity (positive or negative).

However, the zeta potential indicates the stability of the properties of the resulting colloid, and does not directly express reactivity with different substances. It is also known that the pH value itself affects the generation of micro-nano bubbles, but the reactivity of a solution was difficult to distinguish from the acidity or baseness of the solution itself.

For example, Patent Literature 1 below discloses a method for producing nanobubbles by exerting a physical stimulus on microbubbles contained in a liquid to cause the microbubbles to shrink rapidly.

### CITATION LIST

### Patent Literature

Patent Literature 1: International patent Publication No. 2005/084718

### SUMMARY

### Problem to be Solved by the Invention

However, the above-mentioned conventional bubbles have the following problem.

With the method for producing nanobubbles disclosed in the above Patent Literature 1, if the reactivity of the nanobubbles is defined only by their diameter, pH value, and surface potential, a problem is that it is difficult to accurately identify nanobubbles having the desired function or effect.

Also, in applying nanobubbles in the fields of fresh foods, cosmetics, health and medical, etc., changes in the properties of the nanobubbles after their application can significantly influence the final effect, making it necessary to understand the intrinsic value that indicates the reactivity of the nanobubbles, apart from the acidity or baseness of the solution, and to control and utilize this value.

It is an object of the present disclosure to provide a bubble and a bubble aggregate, bubble water, an oxidant, a reductant, and a bubble producing method with which the performance thereof can be controlled using an indicator of reactivity.

### Means for Solving Problem

The bubble according to the present disclosure is a bubble generated in a liquid, and has different isoelectric point (PI) value depending on the change in the pH value of the liquid, within a pH value range of 3 to 11.

### Effects

With the bubble according to the present disclosure, the performance of the bubble can be controlled using an indicator of reactivity.

### BRIEF DESCRIPTION OF THE DRAWINGS

FIG. 1 is a diagram of the nanobubbles according to an embodiment of the present disclosure;

FIG. 2A is a graph of the distribution of the diameter and number of nanobubbles at a pH value of about 5.8 immediately after the nanobubbles were generated by controlling the water flow while circulating water with a pump, and the circulation was stopped;

FIG. 2B is a graph of the distribution of the diameter and number of nanobubbles when the pH value of the bubble water containing the nanobubbles of FIG. 2A is changed to about 4.8;

FIG. 2C is a graph of the distribution of the diameter and number of nanobubbles when the pH value is set to about 4.1;

FIG. 3A is a graph of the distribution of the diameter and number of nanobubbles when the pH value is set to about 3.1;

FIG. 3B is a graph of the distribution of the diameter and number of nanobubbles when the pH value is set to about 6.1;

FIG. 3C is a graph of the distribution of the diameter and number of nanobubbles when the pH value is set to about 9.9;

FIG. 4A is a graph of the zeta potential of the nanobubbles when the pH value of FIG. 2A is set to about 5.8;

FIG. 4B is a graph of the zeta potential of the nanobubbles when the pH value of FIG. 2B is set to about 4.8;

FIG. 4C is a graph of the zeta potential of the nanobubbles when the pH value of FIG. 2C is set to about 4.1;

FIG. 5A is a graph of the zeta potential of the nanobubbles when the pH value of FIG. 3A is set to about 3.1;

FIG. 5B is a graph of the zeta potential of the nanobubbles when the pH value of FIG. 3B is set to about 6.1;

FIG. 5C is a graph of the zeta potential of the nanobubbles when the pH value of FIG. 3C is set to about 9.9;

FIG. 6 is a graph of the relation between the pH value of bubble water containing the nanobubbles of FIG. 1 and the zeta potential of the nanobubbles;

FIG. 7 is a graph indicating that nanobubbles with a changed PI value were generated by changing the pH value of bubble water containing nanobubbles in the graph of FIG. 6 to invert the sign of the zeta potential, and then changing the pH value in the opposite direction;

FIG. 8 is a flowchart of the flow of processing in the nanobubble manufacturing method shown in FIG. 1;

FIG. 9A is a graph of the distribution of the diameter and number of nanobubbles at a pH value of about 5.540 immediately after nanobubbles were generated by controlling water flow or the like and circulation was stopped;

FIG. 9B is a graph of the distribution of the diameter and number of nanobubbles when the pH value of the bubble water containing the nanobubbles of FIG. 9A is increased to about 6.642;

FIG. 9C is a graph of the distribution of the diameter and number of nanobubbles when the pH value is set to about 7.596;

FIG. 10A is a graph of the distribution of the diameter and number of nanobubbles when the pH value is set to about 8.846;

FIG. 10B is a graph of the distribution of the diameter and number of nanobubbles when the pH value is set to about 6.812;

FIG. 10C is a graph of the distribution of the diameter and number of nanobubbles when the pH value is set to about 5.404;

FIG. 11A is a graph of the zeta potential of nanobubbles at a pH value of about 5.540 immediately after nanobubbles are generated by controlling the water flow or the like and the circulation is stopped;

FIG. 11B is a graph of the zeta potential of the nanobubbles when the pH value of the bubble water containing the nanobubbles of FIG. 11A is increased to about 6.642;

FIG. 11C is a graph of the zeta potential of the nanobubbles at a pH value of about 7.596;

FIG. 12A is a graph of the zeta potential of the nanobubbles at a pH value of about 8.846;

FIG. 12B is a graph of the zeta potential of the nanobubbles at a pH value of about 6.812;

FIG. 12C is a graph of the zeta potential of the nanobubbles at a pH value of about 5.404; and

FIG. 13 is a graph indicating that the pH value of bubble water containing nanobubbles having the zeta potential shown in FIGS. 11A to 12C is increased to a value of 9.0, and then the pH value is changed in the opposite direction to generate nanobubbles with changed PI values.

### DETAILED DESCRIPTION OF THE EMBODIMENT

Embodiments will now be described through reference to the drawings. However, some unnecessarily detailed description may be omitted. For example, detailed description of already known facts or redundant description of components that are substantially the same may be omitted. This is to avoid unnecessary repetition in the following description, and facilitate an understanding on the part of a person skilled in the art.

The applicant has provided the appended drawings and the following description so that a person skilled in the art might fully understand this disclosure, but does not intend for these to limit what is discussed in the patent claims.

### Embodiment 1

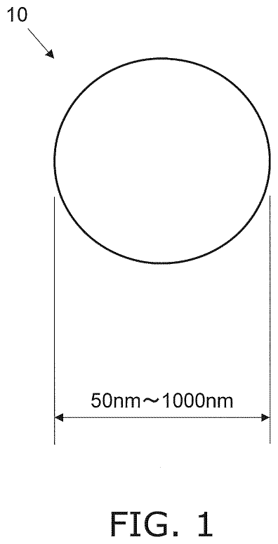

The bubbles according to an embodiment of the present disclosure will now be described with reference to FIGS. 1 to 13.

The bubbles 10 according to this embodiment are, for example, electrically charged bubbles contained in water (a liquid), and include, for example, nanobubbles having a diameter in the range of 50 nm to 1000 nm, as shown in FIG. 1. The bubbles 10 go through the stages of “rising,” “contracting,” and “popping” in water, disappearing within a few hours to a few weeks, and provide an effect according to their intended use, such as cleaning, sterilization, or deodorization.

Also, distilled water, ultrapure water, or the like can be used as the bubble water (liquid) containing the bubbles 10, for example. In addition to distilled water or ultrapure water, the liquid containing the bubbles 10 can also be an aqueous liquid, including an aqueous solution in which the ion product of water is established.

When the bubbles 10 of this embodiment are given a negative or negative zeta potential at the time of their generation, they are generated from bubbles having a diameter of 50 nm to 1000 nm by using a device (such as a screw or other such rotor) that controls the water flow, while circulating the water with an ordinary pump. At this point, the bubble water containing the bubbles 10 immediately after the pump circulation is stopped takes in carbon dioxide (CO₂) from the air, etc., which changes the pH value of the bubble water.

In this embodiment, after the pH value of the bubble water has stabilized (for example, after the bubble water has stood for about 20 minutes), 0.01 N of HCl (cation) and 0.01 N of KOH (anion) are added dropwise to change the pH value of the bubble water. Once the pH value has stabilized, the size and zeta potential of the bubbles 10 in the collected bubble water are measured by dynamic light scattering (DLS) or the like.

That is, the bubbles 10 in this embodiment are generated, for example, by stabilizing the pH value of bubble water containing bubbles generated by controlling the water flow while circulating ultrapure water with a pump, and then dropping in cations (positively charged ions) and anions (negatively charged ions) as discussed above to change the pH value of the bubble water to the negative or positive side (first direction) until the sign of the zeta potential of the bubbles is reversed. The bubbles 10 change into bubbles with different PI values (isoelectric points) before and after the sign of the zeta potential is reversed.

The diameter of the bubbles 10 is calculated using the following Stokes-Einstein equation. The diffusion coefficient D is determined by analysis of an autocorrelation function.

$${D}_{H} = \frac{kT}{3 π η D} \qquad Mathematical Formula 1$$

(where D_{H} is the hydrodynamic diameter, D is a diffusion coefficient, k is a Boltzmann constant, T is the temperature (K), and η is the viscosity)

Dynamic light scattering (DLS) is a technique for measuring with high precision the microparticles contained in a suspension or emulsion, and particle diameters of just a few microns, the zeta potential, and the molecular weight can be measured, for example, on the basis of Brownian motion (small particles move quickly and large particles move slowly).

Also, in dynamic light scattering (DLS), particles undergoing Brownian motion are irradiated with a laser beam, and a scattered light signal is detected at a certain angle. The scattered light is analyzed as fluctuations in light intensity or frequency corresponding to the particle size, and frequency analysis is performed in the frequency range of 1 Hz to 100 KHz.

In addition to dynamic light scattering (DLS), other methods that can be used to measure the behavior of the bubbles include particle trajectory analysis, laser diffraction and scattering, electrical sensing zone method, resonance mass measurement, dynamic image analysis, and the like.

Also, the zeta potential of the bubbles 10 can be measured by electrophoresis, for example. In electrophoresis, when an electric field is applied to charged particles suspended in an electrolyte, the charged particles move at a constant speed toward an electrode having the opposite polarity from the surface charge, so the zeta potential of the bubbles can be measured by applying the following Henry's equation. The mobility of the charged particles is determined by the Doppler shift.

### Mathematical Formula 2

$${U}_{E} = \frac{2 ε z F ( ka )}{3 η} \qquad Mathematical Formula 2$$

(where UE is electrophoretic mobility, z is the zeta potential, ε is a dielectric constant, η is the viscosity, and F(ka) is the Henry's constant)

The PI value (isoelectric point) refers to a state in which, in an ampholyte such as an amino acid or a protein, when the hydrogen ion concentration of the solution is changed, the positive and negative charges of the solute particles all drop to zero, and there is no movement even when an electric field is applied. In other words, the PI value (isoelectric point) refers to the pH value at which the charge (effective charge) of all the solute or particles drops to zero when the hydrogen ion concentration (pH value) of the solution is changed in an ampholyte such as an amino acid, a peptide, or a protein, or in a colloid, etc.

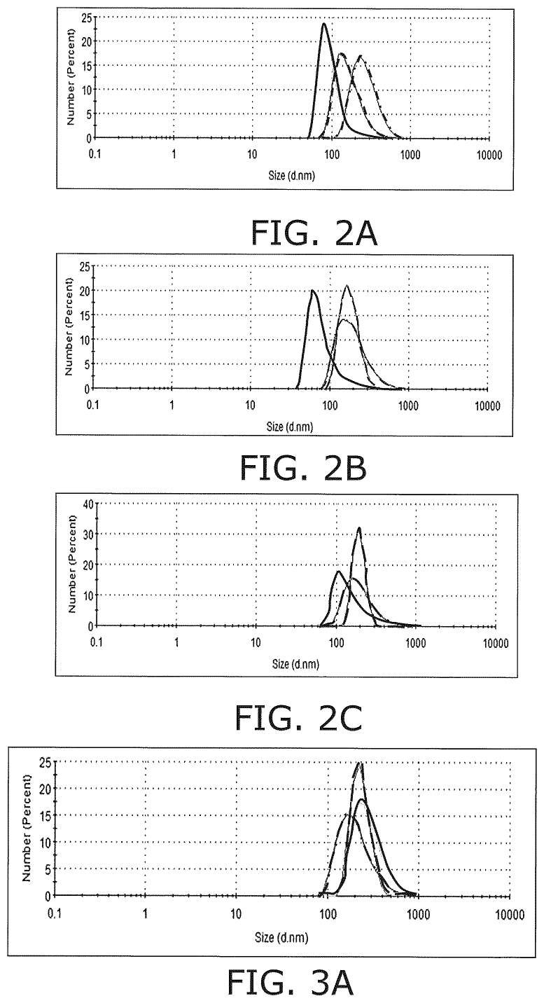

More specifically, FIG. 2A shows data for backscattering (bubble diameter and number (%)) immediately after pump circulation is stopped (pH value of the bubble water is about 5.8).

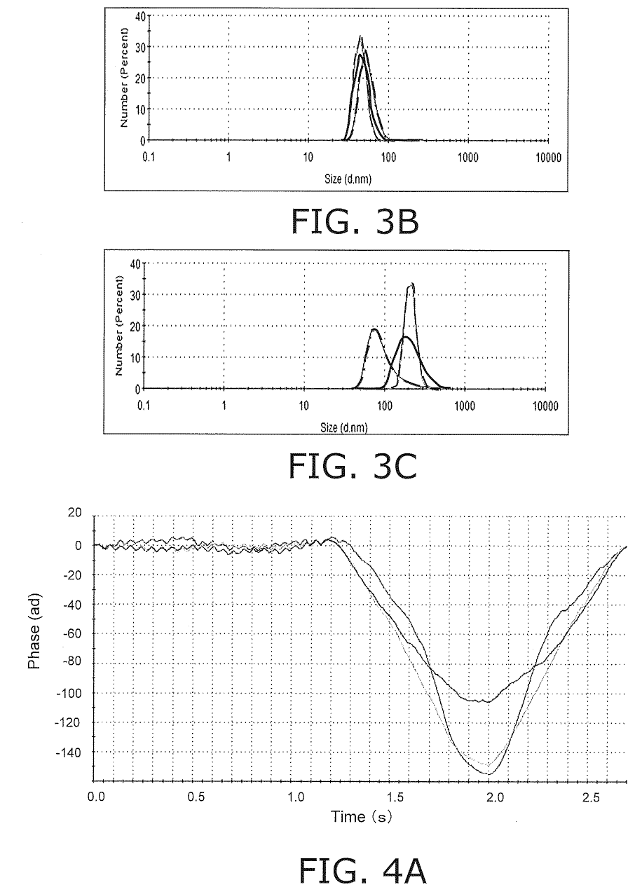

The three curves in the graphs of FIGS. 2A to 3C show the results of three consecutive measurements. The horizontal axis in the graphs of FIGS. 2A to 3C is the diameter of the observed particles (bubbles), and the vertical axis is the number (%) thereof.

FIG. 2B shows data for backscattering (bubble diameter and number (%)) in a stabilized state after the above-mentioned 0.01 N HCl (cation) was added dropwise to the bubble water shown in FIG. 2A to lower the pH value to about 4.8 (shift to the acidic side).

FIG. 2C shows data for backscattering (bubble diameter and number (%)) in a stabilized state after the above-mentioned 0.01 N HCl (cation) was further added dropwise to the bubble water shown in FIG. 2B to lower the pH value to about 4.1 (shift to the acidic side).

FIG. 3A shows data for backscattering (bubble diameter and number (%)) in a stabilized state after the above-mentioned 0.01 N HCl (cation) was further added dropwise to the bubble water shown in FIG. 2C to lower the pH value to about 3.1 (shift to the acidic side).

FIG. 3B shows data for backscattering (bubble diameter and number (%)) in a stabilized state after the above-mentioned 0.01 N KOH (anion) was further added dropwise to the bubble water shown in FIG. 3A to raise the pH value to about 6.2 (shift to the alkaline side).

FIG. 3C shows data for backscattering (bubble diameter and number (%)) in a stabilized state after the above-mentioned 0.01 N KOH (anion) was further added dropwise to the bubble water shown in FIG. 3B to raise the pH value to about 9.9 (shift to the alkaline side).

As shown in the graphs in FIGS. 2A to 3C, from a state in which nanobubbles had been generated by circulating purified water with a pump, the pHI value was lowered by the dropwise addition of cations (positively charged ions), after which the pH value was increased by the dropwise addition of anions (negatively charged ions), and as a result of this change, nanobubbles ranging in a size from 60 nm to 200 nm could be observed in a pH value range of 3.0 to 10.0, and the scattering intensity was also more or less constant.

These observation results reveal that the nanobubbles are in a substantially stable state over a pH value range of 3.0 to 10.0.

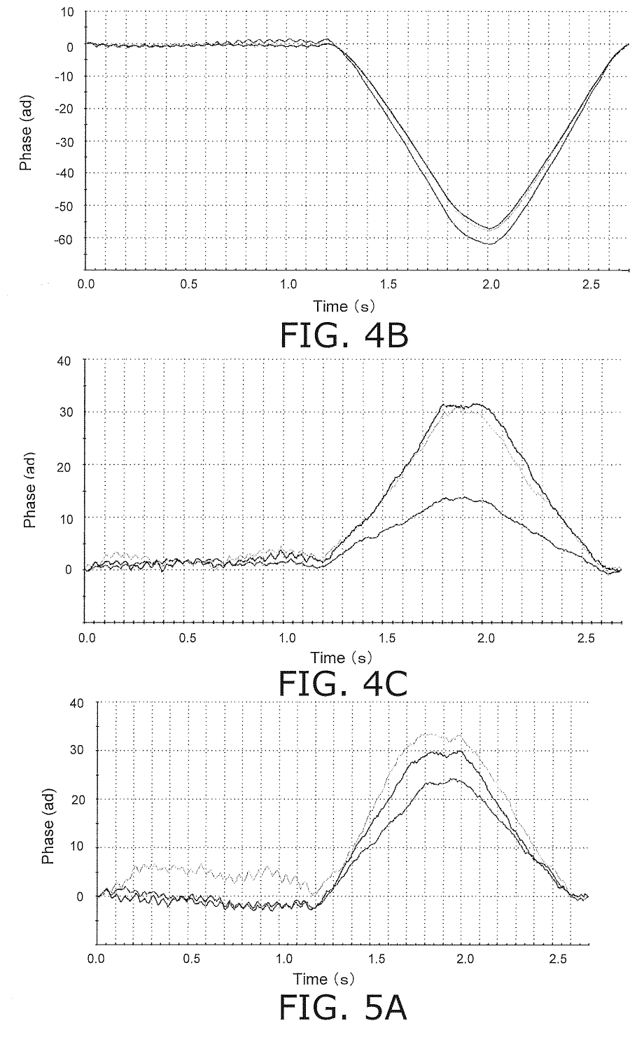

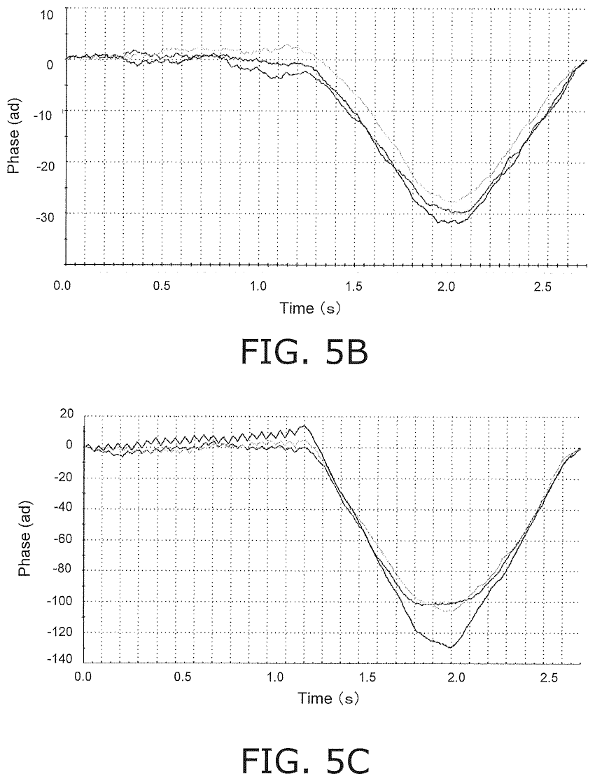

Next, as shown in FIGS. 2A to 3C, the measurement results for the zeta potential of the bubbles 10 when the pH value of the bubble water containing the bubbles 10 is first lowered (first direction) and then increased (second direction) are shown in FIGS. 4A to 5C.

In the graphs of FIGS. 4A to 5C, the horizontal axis is the time (seconds) elapsed since voltage was applied to the electrode portion, and the vertical axis is the mobility (phase (rad)) of the bubbles 10 moving through the bubble water by electrophoresis. The graphs in FIG. 4A to 5C also show data from three consecutive measurements of the behavior of the bubbles 10.

FIG. 4A shows that the zeta potential of the bubble 10 is negative immediately after the pump circulation is stopped (when the pH value of the bubble water is about 5.8).

FIG. 4B shows that in a state in which the above-mentioned 0.01 N HCl (cation) is added dropwise to the bubble water shown in FIG. 4A to lower the pH value to a stable level of about 4.8 (shift to the acidic side), the zeta potential of the bubbles 10 remains negative.

FIG. 4C shows that in a state in which the above-mentioned 0.01 N HCl (cation) is further added dropwise to the bubble water shown in FIG. 4B to lower the pH value to a stable level of about 4.1 (shift to the acidic side), the zeta potential of the bubbles 10 turns positive.

That is, in the case of the bubbles 10 in this embodiment, it can be seen that when the pH value of the bubble water is lowered, the zeta potential turns from negative to positive while the pH value changes from 4.8 to 4.1. Therefore, the PI value (isoelectric point) of the bubbles 10 is between pH values of 4.1 and 4.8.

FIG. 5A shows that in a state in which the above-mentioned 0.01 N HCl (cation) is further added dropwise to the bubble water shown in FIG. 4C to lower the pH value to a stable level of about 3.1 (shift to the acidic side), the zeta potential of the bubbles 10 remains positive.

FIG. 5B shows that in a state in which the above-mentioned 0.01 N KOH (anion) is added dropwise to the bubble water shown in FIG. 5A to raise the pH value to a stable level of about 6.2 (shift to the alkaline side), the zeta potential of the bubbles 10 turns back to negative.

That is, in the case of the bubbles 10 of this embodiment, it can be seen that when the pH value of the bubble water is first lowered and then raised, the zeta potential, which had turned positive, turns back to negative as the pH value changes from 3.1 to 6.2. Therefore, the PI value (isoelectric point) of the bubble 10 is between pH values of 3.1 and 6.2.

FIG. 5C shows that in a state in which the above-mentioned 0.01 N KOH (anion) is further added dropwise to the bubble water shown in FIG. 5B to raise the pH value to a stable level of about 9.9 (shift to the alkaline side), the zeta potential of the bubbles 10 remains negative.

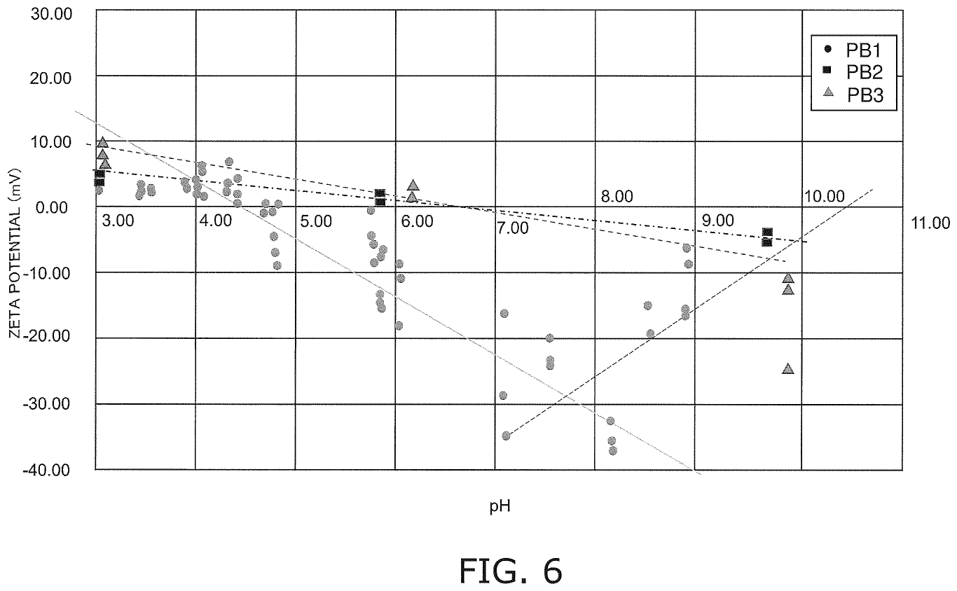

FIG. 6 is a graph of the relation between the pH value of bubble water containing nanobubbles and the zeta potential of the nanobubbles when the pH value of the bubble water containing the bubbles 10 is first lowered (shifted toward the acidic side) and then increased (shifted toward the alkaline side) as shown in FIGS. 4A to 5C.

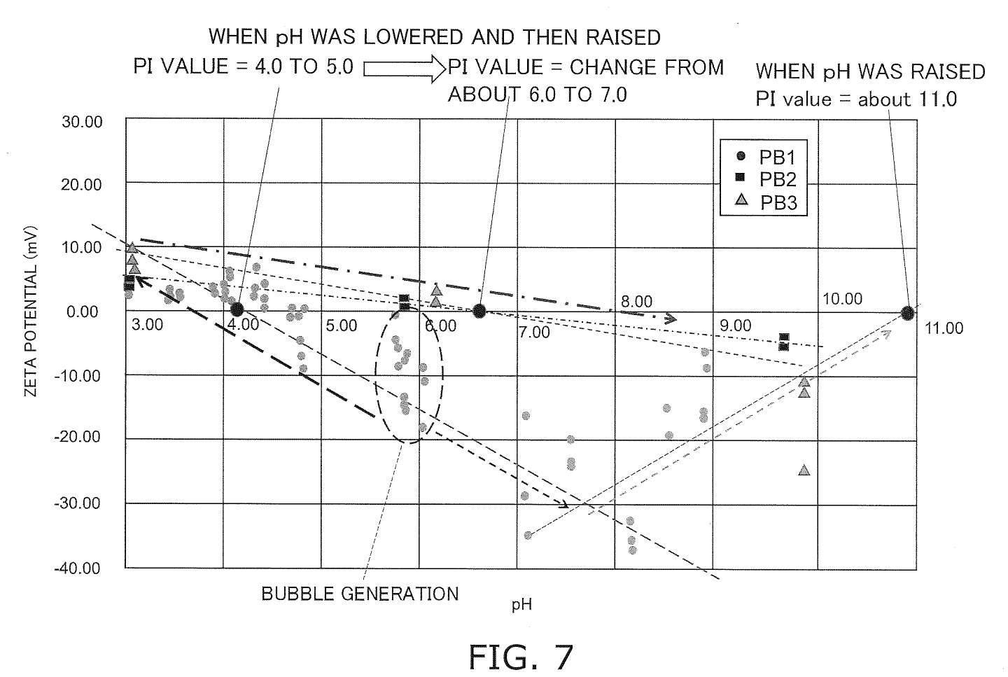

In FIGS. 6 and 7, the plots of PB1, PB2, and PB3 indicate the results of three measurements of bubbles generated with a pump.

It can be seen from FIG. 6 that the zeta potential of the bubbles 10 of this embodiment also changes when the pH value of the bubble water containing the bubbles 10 is changed.

FIG. 7 is a graph that uses the plots shown in FIG. 6 to illustrate the process by which bubbles 10 with different PI values are generated, from the change in the zeta potential of bubbles 10 when the pH value of bubble water containing the bubbles 10 is first lowered and then raised.

That is, as shown in FIG. 7, in this embodiment, the pH value of bubble water containing nanobubbles (with a negative zeta potential) generated by controlling the water flow, etc., while circulating water with a pump or the like stabilizes at around 6.0, and when the pH value is then lowered (see the dashed arrow), the zeta potential of the bubbles 10 drops to zero at a pH value in the range of 4.0 to 5.0, and turns from negative to positive when the pH value is further lowered. That is, the PI value of the bubbles 10 at this point is 4.0 to 5.0.

As shown in FIG. 7, as the pH value of the bubble water is raised from a state in which the zeta potential has turned positive (see the dashed arrow), the zeta potential of the bubbles 10 gradually decreases and reaches zero at a pH value between 6.0 and 7.0, and turns back to negative when the pH value is further raised. That is, the PI value of the bubbles 10 at this point is 6.0 to 7.0.

Based on the above, with the bubbles 10 of this embodiment, the pH value of the bubble water is first lowered, and the zeta potential turns from negative to positive, after which the zeta potential turns from positive to negative when the pH value of the bubble water is raised.

That is, with the bubbles 10, the PI value when the pH value of the bubble water is lowered (first PI value=approximately 4.0) is different from the PI value when the pH value of the bubble water is raised after the zeta potential turns from negative to positive (second PI value=6.7).

Consequently, after bubbles have been generated, if the pH value is changed in a specific direction (negative or positive) (first direction) until the sign of the zeta potential of the bubbles 10 is reversed, and is then changed again in the opposite direction (positive or negative) (second direction) from the specific direction, bubbles 10 with different PI values can be obtained.

Therefore, by changing the pH value of the bubble water to synthesize bubbles 10 with the desired PI value, it is possible to generate bubbles 10 that can be used for the desired purpose (cleaning, sterilization, deodorization, and other applications) by taking into account the PI value as one of the indicators of the reactivity of the bubbles 10.

Also, the zeta potential of bubbles 10 was negative when they were generated (pH value of the bubble water around 6.0), but if the pH value is changed in a specific direction (negative or positive) (first direction) until the sign of the zeta potential of bubbles 10 is reversed, and is then changed again in the opposite direction (positive or negative) (second direction) from this specific direction, bubbles 10 with a positive zeta potential can be obtained at around the same pH value of 6.0.

That is, even if the pH value of the bubble water is the same 6.0, bubbles 10 that show a response from negatively charged bubbles to positively charged bubbles can be obtained before and after the pH value is changed until the sign of the zeta potential is inverted.

Because of the above, in this embodiment, as shown in FIG. 7, when the pH value of the bubble water (liquid) is within the range of 3 to 11 (preferably, 4.0 to 10.0), bubbles 10 having different PI values can be obtained as the pH changes.

In this embodiment, bubbles 10 with different PI values can be synthesized by first lowering the pH value of the bubble water containing nanobubbles generated by controlling the water flow, etc., while circulating ultrapure water with a pump, until the zeta potential of the bubbles 10 is inverted, and then raising the pH value.

Conversely, bubbles 10 with different PI values can also be synthesized by first increasing the pH value of the bubble water containing the generated nanobubbles until the zeta potential of the bubbles 10 is inverted (from positive to negative), and then lowering the pH value after the zeta potential drops to zero (pH value of approximately 11.0).

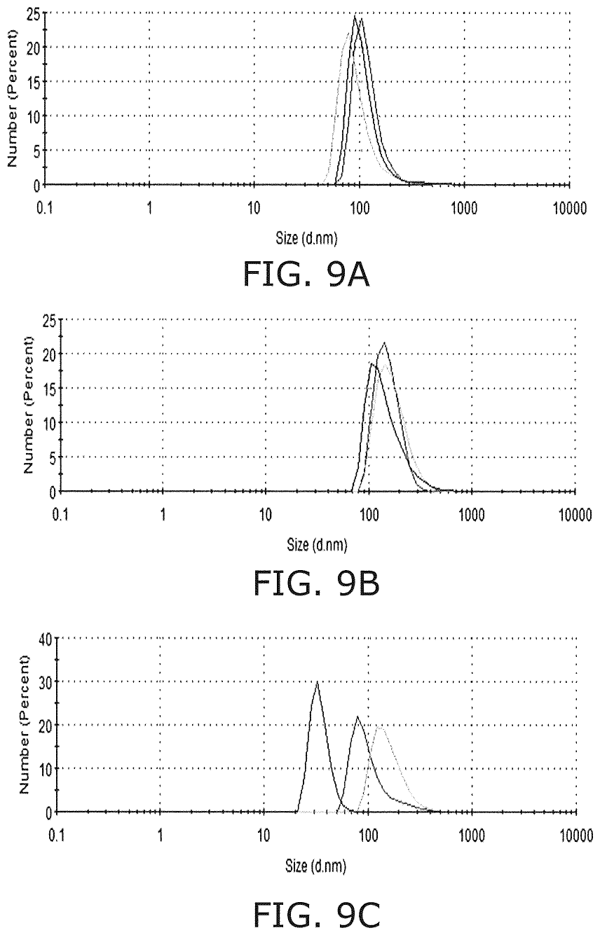

More specifically, FIG. 9A shows data on backscattering (bubble diameter and number (%)) immediately after control of the water flow, etc., was stopped (pH value of the bubble water about 5.540).

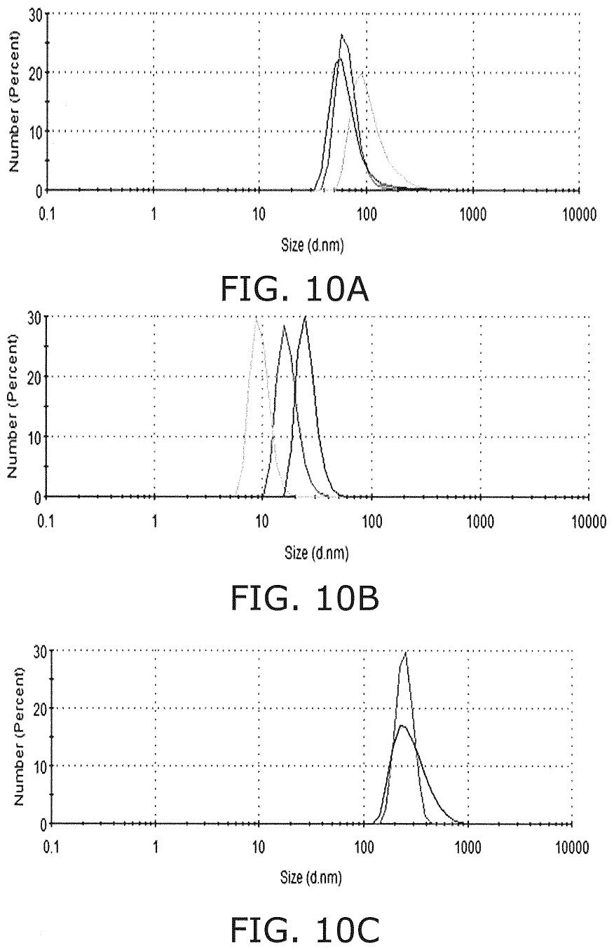

The three plots in the graphs of FIGS. 9A to 10C are the results of three consecutive measurements. Also, the horizontal axis in the graphs of FIGS. 9A to 10C is the diameter of the observed particles (bubbles), and the vertical axis is the number (%) of the particles.

FIG. 9B shows data on backscattering (bubble diameter and number (%)) in a state in which the above-mentioned 0.01 N KOH (anion) was added dropwise to the bubble water shown in FIG. 9A to raise the pH value to a stable level of about 6.642 (shift to the alkaline side).

FIG. 9C shows data on backscattering (bubble diameter and number (%)) in a state in which the above-mentioned 0.01 N KOH (anion) was further added dropwise to the bubble water shown in FIG. 9B to raise the pH value to a stable level of about 7.596.

FIG. 10A shows data on backscattering (bubble diameter and number (%)) in a state in which the above-mentioned 0.01 N KOH (anion) was further added dropwise to the bubble water shown in FIG. 9C to raise the pH value to a stable level of about 8.846.

FIG. 10B shows data on backscattering (bubble diameter and number (%)) in a state in which the above-mentioned 0.01 N HCl (cation) was added dropwise to the bubble water shown in FIG. 10A to lower the pH value to a stable level of about 6.812 (shift to the acidic side).

FIG. 10C shows data on backscattering (bubble diameter and number (%)) in a state in which the above-mentioned 0.01 N HCl (cation) was further added dropwise to the bubble water shown in FIG. 10B to lower the pH value to a stable level of about 5.404.

It can be seen from the graphs in FIGS. 9A to 10C that when nanobubbles were generated by controlling the water flow, etc., anions (negatively charged ions) were added dropwise to increase the pH value, and then cations (positively charged ions) were added dropwise to decrease the pH value, the result was that nanobubbles in the range of 10 nm to 250 nm could be observed at pH values in the range of 5.0 to 9.0, and the scattering intensity was also approximately constant.

From these observation results, it can be seen that the nanobubbles are in a substantially stable state within the pH value range of 5.0 to 9.0.

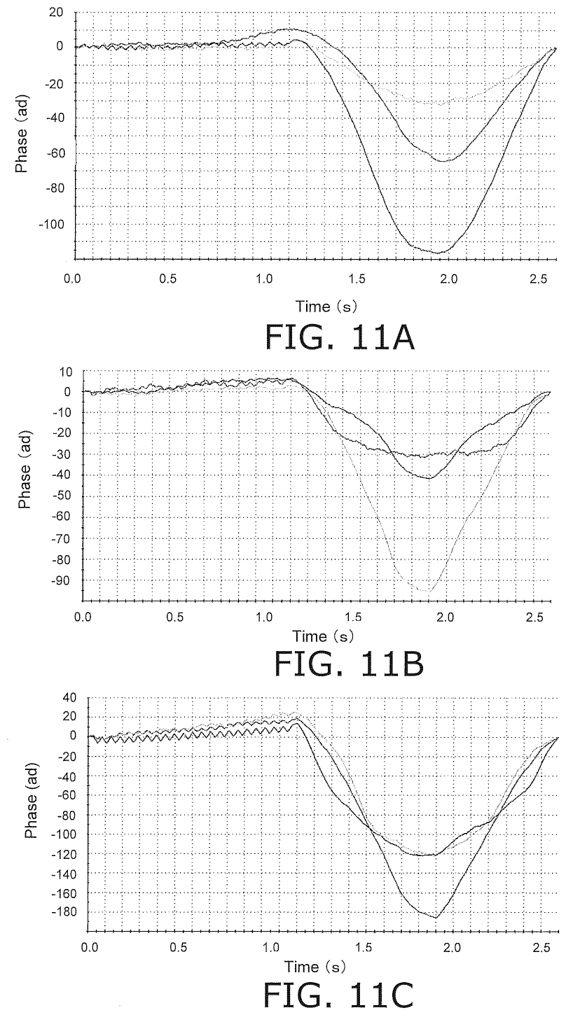

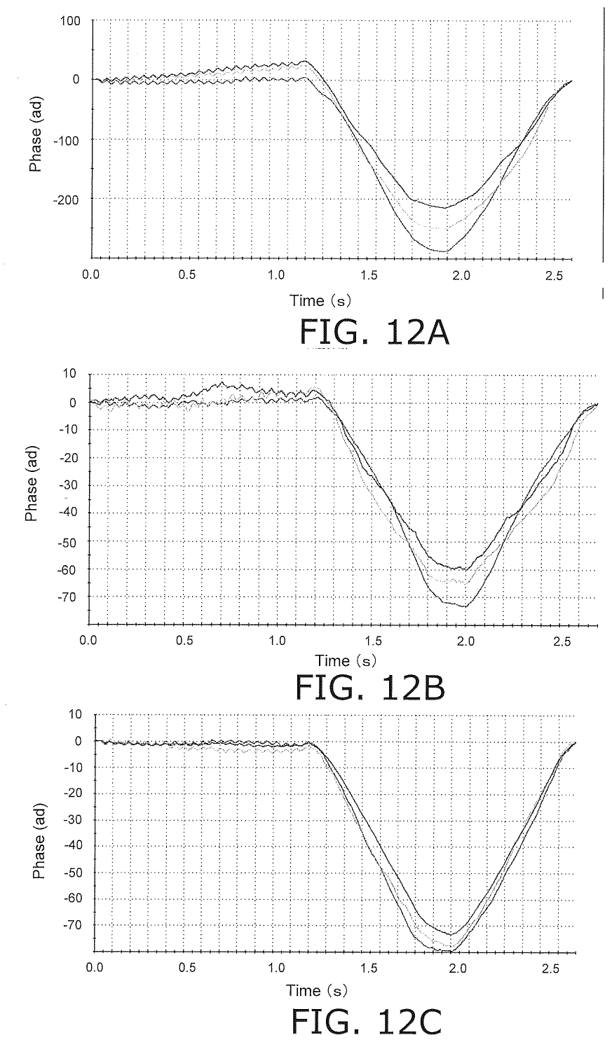

Next, as shown in FIGS. 9A to 10C, when the pH value of bubble water containing the bubbles 10 was first increased and then decreased, the measurement results for the zeta potential of the bubbles 10 are shown in FIGS. 11A to 12C.

In the graphs in FIGS. 11A to 12C, the horizontal axis is the elapsed time (seconds) since a voltage was applied to the electrode portion, and the vertical axis is the mobility (phase (rad)) of the bubbles 10 moving through the bubble water by electrophoresis. The graphs in FIG. 11A to 12C also show data from three consecutive measurements of the behavior of the bubbles 10.

FIG. 11A shows that the zeta potential of the bubbles 10 is a positive value (averaging 8.47) immediately after control of the water flow, etc., is stopped (pH value of the bubble water about 5.540).

FIG. 11B shows that when the above-mentioned 0.01 N KOH (anion) was added dropwise to the bubble water shown in FIG. 11A to raise the pH value to a stable level of about 6.642 (shift to the alkaline side), the zeta potential of the bubbles 10 changed from a positive value to a negative value.

FIG. 11C shows that when the above-mentioned 0.01 N KOH (anion) was further added dropwise to the bubble water shown in FIG. 11B to raise the pH value to a stable level of about 7.596, the negative value of the zeta potential of the bubbles 10 increased.

FIG. 12A shows that when the above-mentioned 0.01 N KOH (anion) was further added dropwise to the bubble water shown in FIG. 11C to raise the pH value to a stable level of about 8.846, the negative value of the zeta potential of the bubbles 10 in the stabilized state further increased.

FIG. 12B shows that when the above-mentioned 0.01 N HCl (cation) was further added dropwise to the bubble water shown in FIG. 12A to lower the pH value to a stable level of about 6.812 (shift to the acidic side), the negative value of the zeta potential of the bubble 10 in the stabilized state decreased.

FIG. 12C shows that when the above-mentioned 0.01 N HCl (cation) was further added dropwise to the bubble water shown in FIG. 12B to lower the pH value to a stable level of about 5.404, the negative value of the zeta potential of the bubbles 10 in the stabilized state decreased.

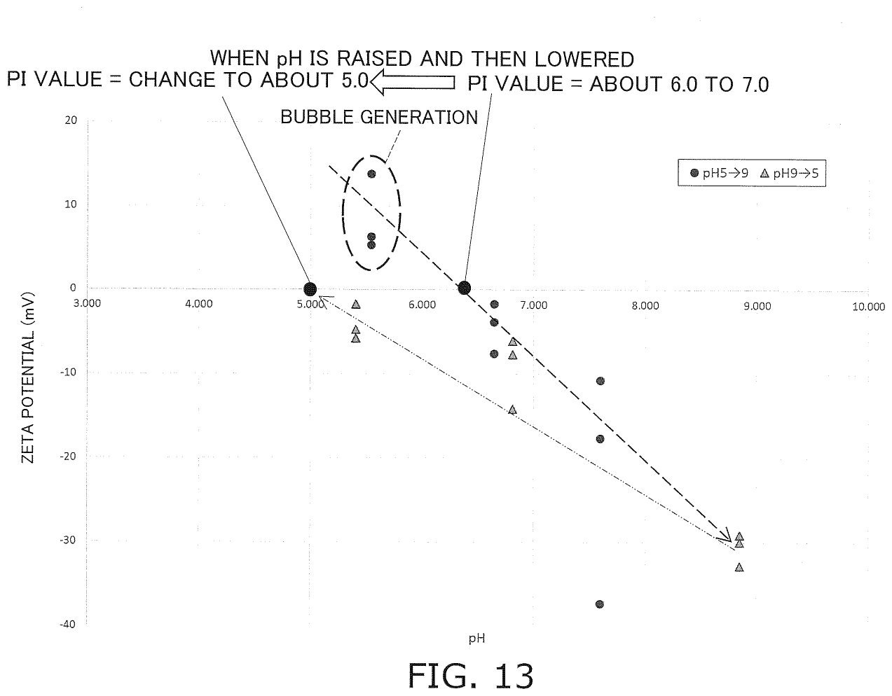

That is, as shown in FIG. 13, in this embodiment, when the pH value of the bubble water is first raised to about 9.0 and then lowered, the isoelectric point (PI) value of the bubbles 10 changes from a pH value range of 6.0 to 7.0 (first isoelectric point) to a pH value of about 5.0 (second isoelectric point) while the pH value changes from about 6.0 to about 9.0, and then to about 5.0.

Because of the above, in this embodiment, as shown in FIG. 13, when the pH value of the bubble water (liquid) was within the range of 3 to 11 (preferably, 5.0 to 9), the zeta potential was a positive value immediately after the bubbles 10 were generated, so bubbles 10 with different PI values (from approximately 6.0-7.0 to approximately 5.0) can be obtained if the zeta potential changes to a negative value as the pH value is increased (first direction), and if the pH value is changed such that after reaching a specific value (pH value 9.0), it decreases again (second direction).

### Method for Manufacturing Bubbles 10

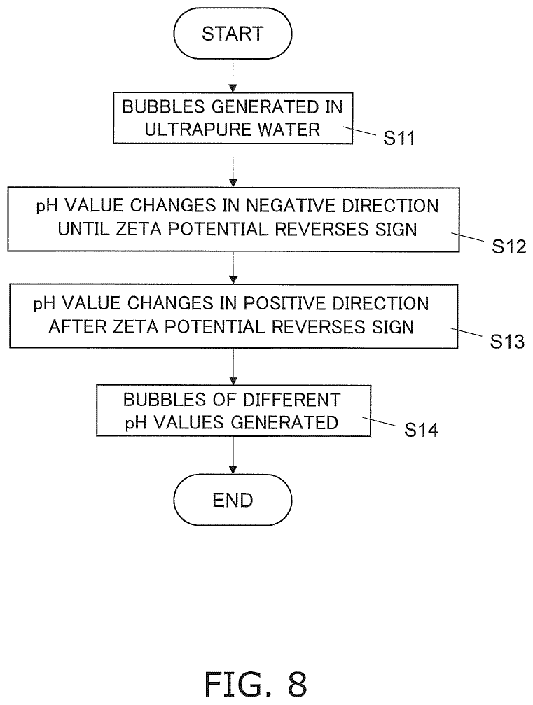

The method for manufacturing the bubbles 10 in this embodiment will now be described with reference to FIG. 8.

As shown in FIG. 8, in step S11, the bubbles 10 are generated as nanobubbles in ultrapure water by using a pump to circulate the ultrapure water while controlling the water flow, etc., during the generation of bubbles having a negative zeta potential immediately after their generation.

In this embodiment, ultrapure water is used as the liquid containing the bubbles 10, but the present disclosure is not limited to this, and an aqueous solution containing anions and cations, such as tap water or alkaline ionized water, can also be used instead of ultrapure water.

Next, in step S12, the pH value of the bubble water is changed in the negative direction (first direction), until the first isoelectric point (PI) value where the zeta potential of the bubble 10 becomes zero when the pH value of the bubble water passes through the first PI value, and its sign is reversed.

In this embodiment, a change in the pH value of the bubble water is accomplished by changing the balance of anions and cations, including H+ and OH−, in the bubble water.

Next, in step S13, the pH value of the bubble water is changed from the state in which the sign of the zeta potential of the bubbles 10 was inverted, in the positive direction (second direction), which is the opposite of the negative direction.

Next, in step S14, bubbles are generated that have different PI values (first PI value, second PI value (second isoelectric point)) before and after the pH value of the bubble water is changed until the sign of the zeta potential of the bubbles 10 is inverted.

As mentioned above, in this embodiment, the PI value is introduced as a new index as the method for defining the reactivity of nanobubbles, making it possible to specifically explain the range of nanobubbles having the desired functions and effects required for household appliances such as refrigerators, washing machines, dishwashers, and facial steamers.

Here, apart from the pH value of the solution containing nanobubbles, nanobubbles in the acidic region with a PI value much lower than pH value 7 are classified as “acidic nanobubbles,” those with a pH value much higher than 7 are classified as “basic nanobubbles,” and those with a pH around 7 are classified as “neutral nanobubbles.”

In a specific example of an application, nanobubbles that exhibit reaction in the alkaline range can be generated in a neutral medium by generating basic nanobubbles with a PI value (isoelectric point) of pH value 10 in an aqueous solution of pH value 6.

Consequently, nanobubble water in the neutral range is easier to handle than acidic or alkaline water, and therefore affords both high safety and high functionality.

Also, in this embodiment, as discussed above, as a method for defining the reactivity of nanobubbles, the PI value can be introduced as a new index to specifically explain the range of nanobubbles having the desired functions and effects required for oxidants and reductants.

For example, it is known that, amino acids with a large PI value are generally electron donors, and amino acids with a small PI value are electron acceptors.

Therefore, the nanobubbles controlled by PI value as in the present disclosure can be used as an oxidant or a reductant by controlling the PI value.

The oxidant referred to here is an agent that accepts electrons from a substance that acts on (reacts with, comes into contact with) the nanobubbles, and the reductant referred to here is an agent that donates electrons to a substance that acts on (reacts with, comes into contact with) the nanobubbles.

### OTHER EMBODIMENTS

An embodiment of the present disclosure was described above, but the present disclosure is not limited to or by the above embodiment, and various modifications are possible without departing from the gist of the disclosure.

### (A)

In the above embodiment, the bubbles 10 were present by themselves in the water. However, the present disclosure is not limited to this.

For example, an aggregate in which a plurality of bubbles are clustered together may be present in water.

Here again, by controlling under the above conditions, the same effect as that obtained in the above embodiment can be obtained even with an aggregate in which a plurality of bubbles are clustered together.

### (B)

In the above embodiment, an example was given in which the balance of anions (KOH) and cations (HCl), including H+ and OH−, was varied in order to change the pH value of the bubble water containing the bubbles 10. However, the present disclosure is not limited to this.

For example, the pH value of the bubble water may be changed by electrolysis of the bubble water.

### (C)

In the above embodiment, an example was given in which the balance of anions (KOH) and cations (HCl), including H+ and OH−, was varied in order to change the pH value of the bubble water containing the bubbles 10. However, the present disclosure is not limited to this.

For example, acidic and alkaline solutions may be used to change the pH value of the bubble water.

### (D)

In the above embodiment, the bubbles 10 of the present disclosure were described. However, the present disclosure is not limited to this.

For example, the present disclosure may be realized as bubble water including the bubbles of the present disclosure and water containing these bubbles.

### (E)

In the above embodiment, an example was given in which, in the initial stage of generating the bubbles 10 of this embodiment, ultrapure water was circulated with an ordinary pump while controlling the water flow, etc., to generate bubble water containing nanobubbles that had a negative zeta potential immediately after generation. However, the present disclosure is not limited to this.

For example, the generation of nanobubbles having a negative zeta potential immediately after generation is not limited to the circulation of ultrapure water by a pump and the control of the water flow, etc., and may instead be accomplished using various kinds of device that generates nanobubbles.

Similarly, the generation of nanobubbles having a positive zeta potential immediately after generation is not limited to the control of water flow, etc., and may instead be accomplished by using various kinds of device that generates nanobubbles.

### INDUSTRIAL APPLICABILITY

The bubbles disclosed herein exhibit the effect that their performance can be controlled using an indicator of reactivity, and therefore can be broadly applied to water, gases, and the like that contain bubbles.

### REFERENCE SIGNS LIST

10 bubbles

What is claimed is:

1. A bubble generated in a liquid,
wherein the bubble has different isoelectric point (PI) value depending on a change in a pH value of the liquid, within a pH value range of 3 to 11.

2. The bubble according to claim 1,
wherein when the pH value of the liquid is changed until a sign of a zeta potential of the bubble is inverted, the PI value is different before and after an inversion.

3. The bubble according to claim 1,
wherein the PI value varies with changes in the pH value of the liquid within a pH value range of 4 to 10.

4. The bubble according to claim 1,
wherein the bubble has a diameter in a range of 50 nm to 1000 nm.

5. A bubble aggregate, comprising
a plurality of the bubbles according to claim 1.

6. Bubble water, comprising:
an aqueous liquid containing the bubble according to claim 1.

7. An oxidant, comprising:
an aqueous liquid containing the bubble according to claim 1,
wherein the oxidant receives electrons from a substance on which the bubble is made to act.

8. A reductant, comprising:
an aqueous liquid containing the bubble according to claim 1,
wherein the reductant donates electrons to a substance on which the bubble is made to act.

9. A method for producing a bubble, comprising:
a step of generating the bubble in a liquid;
a step of changing a pH value of the liquid in a first direction, until a first isoelectric point (PI) value where a zeta potential of the bubble becomes zero when the pH value of the liquid passes through the first PI value, and its sign is reversed; and
a step of changing the pH value of the liquid in a second direction that is opposite the first direction from a state in which a sign of the zeta potential has been inverted, thereby generating bubble having a second isoelectric point (PI) value that is different from the first PI value.

10. The method for producing the bubble according to claim 9,
wherein the pH value of the liquid is changed by changing a balance of anions and cations in the liquid, including H+ and OH−.

11. The method for producing the bubble according to claim 9,
wherein the pH value of the liquid is changed by using acidic and alkaline solutions in the liquid.
